(19) United States
(12) Patent Application Publication
(10) Pub. No.: US 2016/0347108 A1
(43) Pub. Date: Dec. 1, 2016

(54) INTERCHANGEABLE STATIONERY ARTICLES AND METHODS OF USING SAME

(71) Applicant: EC Design LLC, Hawthorne, CA (US)

(72) Inventors: Erin Condren, Hawthorne, CA (US); Danielle Bourret, Hawthorne, CA (US); Carmen Moncayo, Hawthorne, CA (US)

(21) Appl. No.: 15/166,103

(22) Filed: May 26, 2016

Related U.S. Application Data
(60) Provisional application No. 62/167,187, filed on May 27, 2015.
(60) Provisional application No. 62/188,142, filed on Jul. 2, 2015.

(51) Int. Cl. B42F 3/00; B42F 3/06; B42F 3/04; B42F 5/00

(52) U.S. Cl. CPC B42F 3/003; B42F 5/00; B42F 3/06; B42F 3/04

(57) ABSTRACT

Devices and methods are described that can allow or are configured to allow a user to attach and remove or interchange different stationery articles to a binding mechanism, for example, a substantially cylindrical binding mechanism.

### CROSS REFERENCE TO RELATED APPLICATIONS

This application claims the benefit of U.S. provisional patent application Nos. 62/167,187, filed May 27, 2015 and 62/188,142, filed Jul. 2, 2015, the entire disclosures each of which are incorporated herein by reference.

### SUMMARY

Devices and methods are described that can allow or are configured to allow a user to attach and remove or interchange different stationery articles to a binding mechanism, for example, a substantially cylindrical binding mechanism. In some embodiments, these stationery articles can be covers and/or dashboards. Covers and/or dashboards can include front covers and back covers. In other embodiments, the articles can be day planner inserts, information inserts, rulers, protractors, photograph sleeves, and the like. As a non-limiting example, a binding system can include a spiral or coil type of binding system used to create notebooks, planners, pamphlets, booklets or other spiral or coil bound items. In some embodiments described herein, the spiral or coil bound item can be a yearly, monthly, or weekly calendar/planner.

In one embodiment, stationery articles, such as covers and/or dashboards, can comprise: a body section including a top surface, a bottom surface, an inside edge and an outside edge, wherein at least a portion of the inside edge includes two or more securing holes that interchangeably attach the stationery article to a substantially cylindrical binding mechanism.

The stationery articles can include multiple securing holes which each include a hole section and a slice section. In some embodiments, the hole section can have a substantially elliptical shape. A stationery article can include, for example, 21, 44 or 35 hole sections on a given edge. Further, the body section of a stationery article can have a substantially rectangular shape with top and bottom surfaces that are substantially flat.

In one embodiment, the stationery article includes a body including a height from the top edge to the bottom edge of about 11.5 inches. In other embodiments, this height can be about 9.25 inches.

The stationery article can include an insert that is permanent or removable and reinsertable within a pouch and/or through an opening.

In other embodiments, stationery article can include one or more removably attached articles.

Methods of using the stationery articles are also described. The methods can include interchangeably securing a body section of the stationery article to a substantially cylindrical binding mechanism using two or more securing holes.

The methods can allow stationery articles wherein the body section includes a top edge, a bottom edge, an inside edge and an outside edge, wherein at least a portion of the inside edge includes the two or more securing holes to be interchangeably attached to a substantially cylindrical binding mechanism.

The methods can further comprise removing the body section of the stationery article from the substantially cylindrical binding mechanism. This removing can be accomplished using a tearing motion with the body section. The methods can then further comprise re-securing the body section of the stationery article to the substantially cylindrical binding mechanism.

The methods can further include attaching a sleeve with a pocket onto the body section.

The interchangeably securing of the methods includes using force to secure or attach the two or more securing holes onto the substantially cylindrical binding mechanism. In other embodiments, the interchangeably securing of the methods includes using force to secure or attach the hole sections onto the substantially cylindrical binding mechanism through the slice sections.

The methods can further include inserting a loose article into an opening along the top edge of the body section thereby displaying the insert. The loose article can also be inserted into a sleeve that is attachable to a stationery article as described herein.

Additional features and advantages are described herein, and will be apparent from the following Detailed Description and figures.

### BRIEF DESCRIPTION OF THE DRAWINGS

FIG. 1A is a view of a stationery article as described, here an example cover that can be interchangeably attached to a binding mechanism of a bound set of materials such as a notebook. FIG. 1B illustrates another embodiment of a cover including an insert that can be permanently included in the body section of the cover.

FIG. 2 is a zoomed-in view of the securing holes and binding mechanism of FIG. 1A.

FIG. 3 is another alternate cover as described herein that can be interchangeably attached to a bound set of materials such as a notebook and an attachable sleeve.

FIG. 4A is an embodiment of a cover including a sleeve stuck to the cover. FIG. 4B is a cross-section through FIG. 4A.

FIGS. 5A and 5B illustrate another stationery article as described herein that can be interchangeably attached to a binding mechanism of a bound set of materials such as a notebook. FIG. 5C illustrates another stationery article as described herein that can be interchangeably attached to a binding mechanism of a bound set of materials such as a notebook.

FIG. 6 is a view of another cover including a window that can be interchangeably attached to a binding mechanism of a bound set of materials such as a notebook.

FIG. 7 illustrates an embodiment of a dashboard that can be interchangeably attached to a binding mechanism as described herein.

### DETAILED DESCRIPTION

Described herein generally are stationery products and devices that can allow a user to attach and remove, or interchange stationery articles, such as a cover and/or a dashboard, from a binding mechanism. In some embodiments, the stationery articles can be used to clip or secure a loose cover, dashboard, or other stationery articles to a binding mechanism. In other embodiments, the binding mechanism is substantially cylindrical. The covers and/or dashboards described herein can be front covers or back covers. Further still, the covers and/or dashboards can be inserted into a bound notebook to be a front or back cover for an article within a bound notebook. I other words, there is no limitation that cover is only a front cover. In some embodiments, the covers and/or dashboards can be inserts.

Interchangeable, or insertable and removable stationery articles as described herein can be useful for inserting and/or removing the articles from a binding mechanism for example, to change the outer appearance of a bound notebook or planner. Stationery articles can include, but are not limited to, a cover, a dashboard, a binder cover, a divider, a bookmark, a ruler, or the like. Stationery articles can be secured to the binding mechanism of bound notebooks, planners, scrapbooks, manuals, medical notebooks, lab notebooks, and the like. In some embodiments, a planner may be a notebook or within a notebook. In other embodiments, a planner may be a completely separate article.

In one embodiment, the spiral bound booklet can be a personal planner, such as, but not limited to, a yearly planner, a wedding planner, a monthly planner, a career planner, a lesson planner, a work planner, a meal planner, or a schedule planner. In other embodiments, the spiral bound booklet can be a notebook such as, but not limited to, a school notebook, a college notebook, a teacher's notebook, baby notebook, a scrapbook, a photo notebook, or the like.

Binding mechanisms, e.g., substantially cylindrical binding mechanisms can be spiral or coil binding, comb binding, double loop binding (e.g., Wire-O binding), and ring binding. In some embodiments, the binding mechanisms can be formed of polymers such as plastics and thermosets, metal wires, cylinders or tubing, or a combination of metals and polymers such as coated metal wires. In some embodiments, the binding can lock and unlock. However, to use the presently described stationery articles, the binding mechanism does not need to lock and unlock.

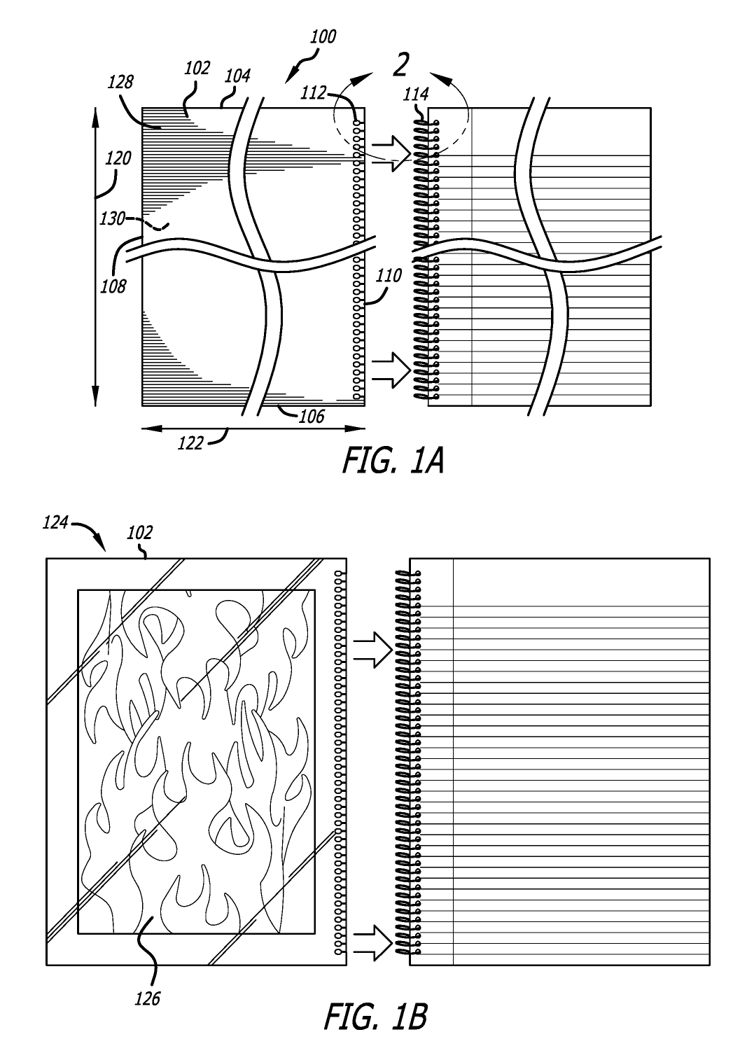

An example of an interchangeable stationery article as described herein, cover 100, is illustrated in FIG. 1A. The stationery article illustrated in FIG. 1A is for illustration only and shapes and sizes of various features can be varied. Cover 100 can include a body section 102. Body section 102 can include a top edge 104, a bottom edge 106, an outside edge 108, and an inside edge 110. In some embodiments, top edge 104, and bottom edge 106, and outside edge 108 are substantially flat thereby forming a substantially rectangular or square shape. In some embodiments, cover 100 is substantially flat.

Cover 100 also includes at least two securing holes 112 configured to secure body section 102 to a substantially cylindrical binding mechanism 114. Securing holes 112 can be located on inside edge 110. However, in other embodiments, securing holes 112 can be located on top edge 104, bottom edge 106, and/or outside edge 108.

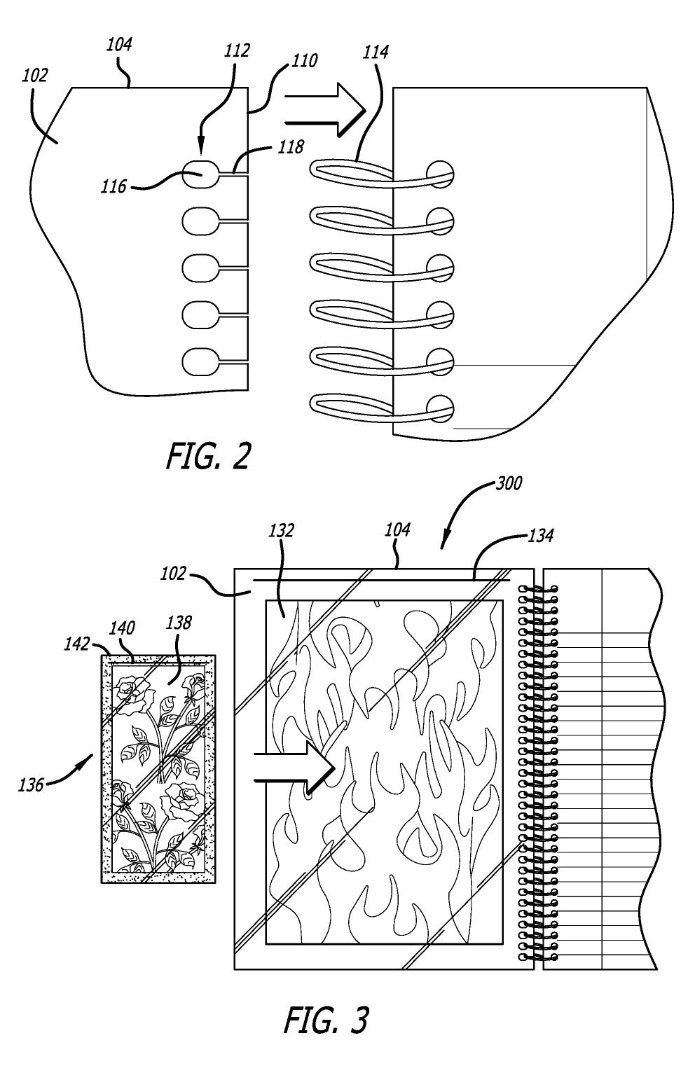

Each securing hole 112, as illustrated in FIG. 2, can include a hole section 116 and a slice section 118. Hole section 116 can be any shape that can allow cover 100 to rest securely within substantially cylindrical binding mechanism 114. In one embodiment, hole section 116 can be substantially circular, substantially elliptical, substantially triangular, or substantially diamond shaped. In some embodiments, other rectilinear shapes can be used. In various embodiments, the above shapes and any other shapes described herein can include curved corners.

In one embodiment, cover 100 can include two, three, four, five, six, seven, eight, nine, ten, eleven, twelve, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 or more hole sections. Some embodiments, such as that illustrated in FIG. 1A can include 35 hole sections. Other embodiments, such as that illustrated in FIG. 1B can include 44 hole sections. However, covers and stationery articles as described herein can include any appropriate number of hole sections.

In some embodiments, hole sections need not cover an entire edge of a cover. In some embodiments, hole sections can be located at the top and bottom of a particular edge and secure the cover in these locations. Hole sections can be provided in clusters along an edge. For example, a cluster of four or more hole sections can be located at three, four, five or more locations along one or more edges.

In another embodiment, a cluster of hole sections can be located at the top and middle of a particular edge. In another embodiment, a cluster of hole sections can be located at the bottom end of an edge and a cluster of hole sections can be located at the middle portion of the edge. In still another embodiment, a cluster of hole sections can be located at the top end of an edge and a cluster of hole sections can be located at the bottom end of the edge. In still another embodiment, a cluster of hole sections can be located at the top end of an edge, a cluster of hole sections can be located at the middle portion of the edge, and a cluster of hole sections can be located at the bottom end of the edge. Each cluster described can have any number of hole sections. Also, any number of clusters can be used on any number of edges.

Slice section 118 can allow a portion of substantially cylindrical binding mechanism 114 to pass through to hole section 116. Slice section 118 can be a straight cut section. In other embodiments, slice section can have a “V” shape to more securely lock a portion of substantially cylindrical binding mechanism 114 into hole section 116. Further, zig-zag patterns can be used to more securely lock the system together while still allowing the cover to be removed from the substantially cylindrical binding mechanism.

FIG. 1A shows cover 100 as having a height and width that can vary between embodiments. The wavy line portions illustrate a portion of cover 100 that can be varied between embodiments. For example, in FIG. 1A, the height and width of cover 100 can vary between embodiments.

Further, body section 102 can include inside edge 110 that includes at least two hole sections 112 that is substantially straight but has an outside edge 108 that is curved.

Cover 100 can include body section 102 that is dimensioned for a particular application and/or dimensioned to fit within or along a particular binding mechanism. For example, body section 102 can include a height 120. Height 120 of body section 102 can be long enough to provide enough hole sections 112 to secure a stationery article, such as a cover, to a binding mechanism. In some embodiments, height 120 can be about 12 inches, about 11.5 inches, about 11 inches, about 10.5 inches, about 10 inches, about 9.5 inches, about 9.25 inches, about 9 inches, about 8.5 inches, about 8 inches, between about 12 inches and about 11 inches, or between about 9 inches and about 10 inches.

Further, body section 102 can include a width 122. Width 122 of body section 102 can be long enough to provide enough surface area for a particular application. In some embodiments, width 122 can be about 10 inches, about 9 inches, about 8 inches, about 7 inches, about 7.5 inches, about 7.25 inches, about 7 inches, about 6.5 inches, about 6 inches, about 5.5 inches, about 5 inches, about 4.5 inches, about 4 inches, about 3.5 inches, abut 3 inches, between about 10 inches and about 8 inches, between about 7 inches and about 6 inches, or between about 4 inches and about 3 inches.

As illustrated in FIG. 1B, cover 124 can include a smaller insert 126 within body section 102. Insert can be a piece of paper, a thin sheet of metal or metal alloy, a thin sheet of plastic or other polymer, combinations thereof or the like.

In some embodiments, body section 102 is formed of a transparent material and insert 126 can be of any color or design that can show through the transparent material that forms body section 102.

Cover 100 can further include a first surface 128 and second surface 130. In some embodiments, if cover 100 is to be used as a front cover, first surface 128 can be an inside surface and second surface 130 can be an outside surface. Likewise, if cover 100 is to be used as a back cover, first surface 128 can be an outside surface and second surface 130 can be an inside surface. In still other embodiments, a cover may not be used on the outside of the bound document, but may be used within the bound document as a divider, a place card, a bookmark, or the like.

First surface 128 and/or second surface 130 can be a printable surface that can allow company logos, personal information, sayings, instructions, photographs, pictures other than photographs, artwork, designs, or other information to be printed thereon or therein. In some embodiments, first surface 128 and/or second surface 130 can be conducive to permanent markings such as permanent markers or can be conducive to removable markings such as erasable markers.

In other embodiments, insert 126 is printed upon and then encased in the body section. Insert can be customized before being inserted into the body section. For example, company logos, personal information, sayings, instructions, photographs, pictures other than photographs, artwork, designs, or other information to be printed or otherwise written or marked thereon or therein.

Further, top surface 104 and/or bottom surface 106 can be textured to allow for easy handling and gripping during use.

Cover 100 can be formed of materials that can sustain the forces placed on them by the article attached to them. For example, cover 100 can be formed of metal, polymeric materials, plastics, or a combination thereof such as a polymer coated material. Covers or any stationery articles described herein can be formed of a transparent material. Transparent can include fully transparent, substantially transparent, or partially transparent. Covers can also optionally include an insert within or on the transparent or partially transparent portion. In some embodiments, the materials and methods chosen to form the herein described articles, such as covers, can be those that provide the thinnest and lightest final product. The thinner the cover, generally the lighter the resulting bound booklet, notebook, or pamphlet can be.

For example, in some embodiments, cover 100 can be formed of a plastic or other polymeric material such as, but not limited to rubber, synthetic rubber, polyesters, silicone polymers, thermoplastics, thermosets, polyolefins, polyisobutylene, acrylic polymers, ethylene-co-vinylacetate, polybutylmethacrylate, vinyl halide polymers (for example, polyvinyl chloride), polyvinyl ethers (for example, polyvinyl methyl ether), polyvinylidene halides, polyacrylonitrile, polyvinyl ketones, polyvinyl aromatics, polyvinyl esters, acrylonitrile-styrene copolymers, ABS resins, ethylene-vinyl acetate copolymers, polyamides (for example, Nylon 66 and polycaprolactam), alkyd resins, polycarbonates, polyoxymethylenes, polyimides, polyethers, epoxy resins, polyurethanes, rayon, cellulose, cellulose acetate, cellulose butyrate, cellulose acetate butyrate, cellophane, cellulose nitrate, cellulose propionate, cellulose ethers, carboxymethyl cellulose, polytetrafluororethylene (for example, TEFLON®) and combinations thereof. In some embodiments, cover 100 can be a plastic or other polymeric material coated onto or covering a paper product. In one embodiment, the cover can be made of a polyester based material with a co-polymer low-melt aggressive adhesive. The cover can be 5 mil, 10 mil, 20 mil, 30 mil or more in thickness.

Also, in other embodiments, cover 100 can be formed of a metal such as, but not limited to aluminum, titanium, zinc, platinum, tantalum, copper, nickel, rhodium, gold, silver, palladium, chromium, iron, indium, ruthenium, osmium, tin, iridium, or combinations, and alloys thereof.

Again, stationery articles or covers can be formed of metal or a textile such as paper and coated or encased in a polymer or plastic. In some embodiments, the encasement can be a lamination.

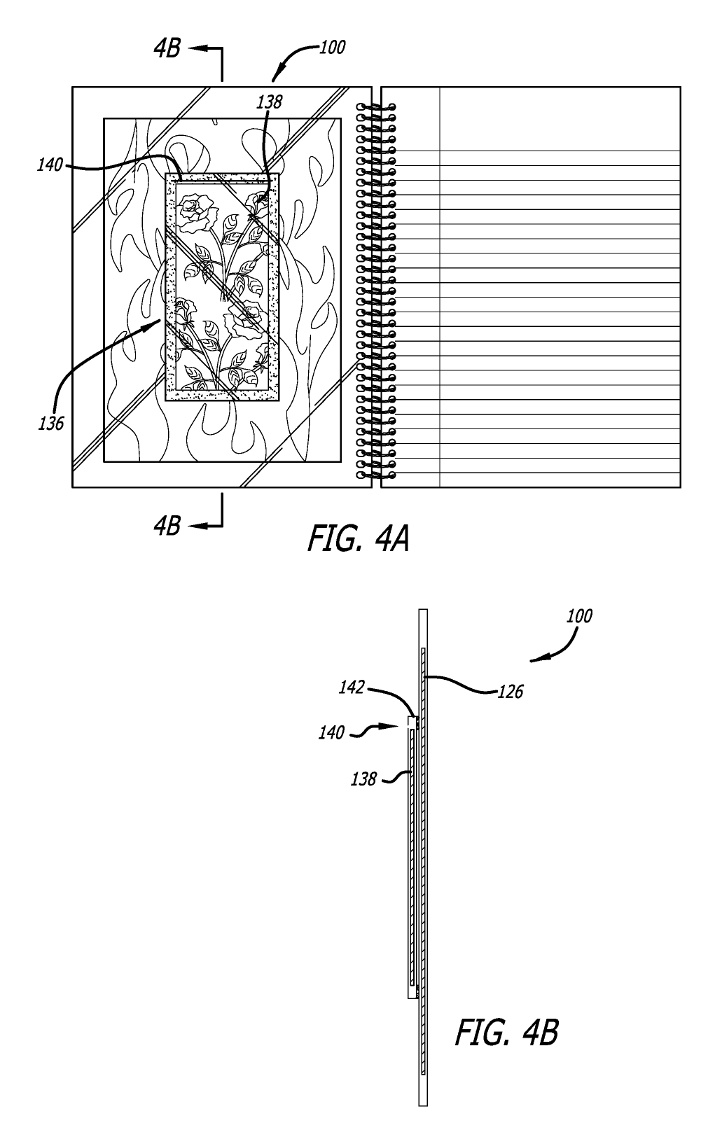

In one embodiment, as Illustrated in FIG. 3, cover 300 can include an optional removable insert 132 in body section 102. Here, removable insert 132 can be removed from body section through opening 134 along top edge 104. Opening 134 can be located along any edge of body section 102 or any other appropriate location that allows removal and insertion of removable insert 132 into body section 102. Opening 134 can be opened and closed using mechanisms such as zippers, zip locks, adhesives, Van deer Walls forces, ionic forces, static forces, combinations thereof, and the like. In one embodiment, a mechanism may not be needed. In such an embodiment, removable insert 132 is simply slid into body section 102 through opening 134 and stays in place by appropriate compression, static, or other forces.

In another embodiment, cover 300 can include an optional sleeve 136 in or on body section 102. Here, sleeve 136 can allow a removable article 138 to be placed within sleeve 136 through sleeve opening 140. For example, a picture can be placed inside sleeve 136 and can be removed from sleeve through opening 140 along top edge 142. Sleeve opening 140 can be located along any edge of sleeve 136 or any other appropriate location that allows removal and insertion of removable article 138 into the sleeve. Opening 140 can be opened and closed using mechanisms such as zippers, zip locks, adhesives, Van deer Walls forces, ionic forces, static forces, combinations thereof, and the like. In one embodiment, a mechanism may not be needed. In such an embodiment, removable article 138 is simply slid into body section through sleeve opening 140 and stays in place by appropriate compression, static, or other forces.

Sleeve 136 can further include an adhesive or other attachment mechanism to be able to stick it to a cover such as cover 100 or cover 300. In some embodiments, the bottom surface includes an adhesive.

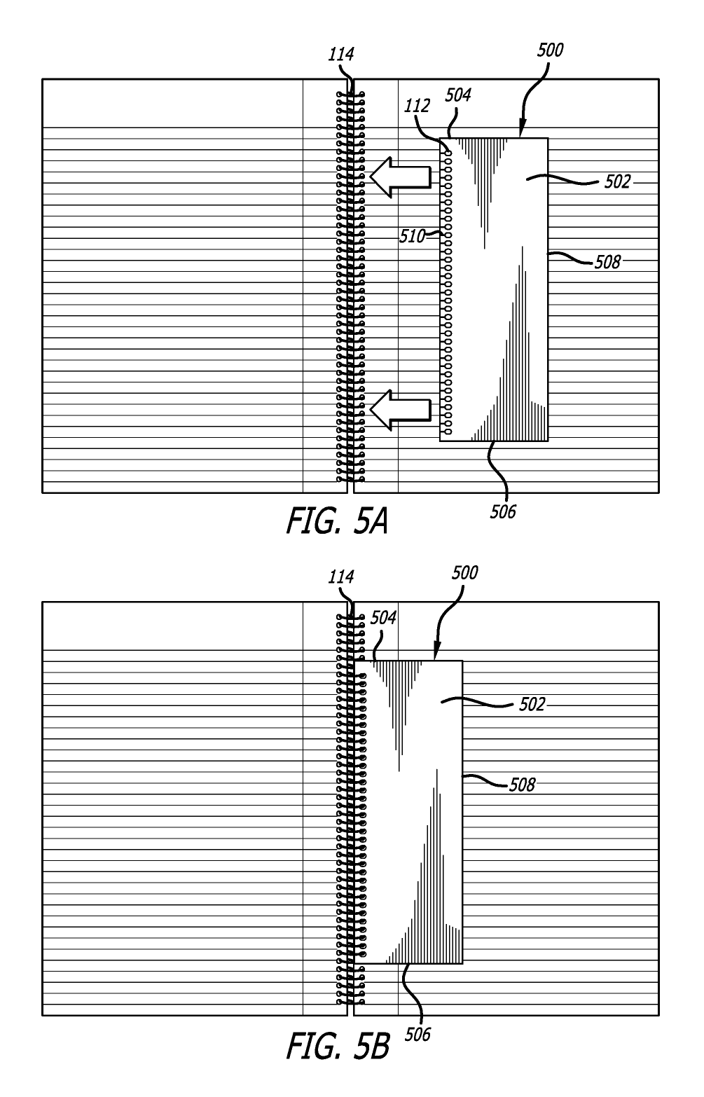

As illustrated in FIG. 4A, sleeve 136 is stuck to an inner surface of cover 100. Sleeve 136 is stuck to the center of cover 100 but can be stuck in other locations as well. The cross-section of FIG. 4B illustrates that cover 100 can include insert 126 within body section 102 and sleeve 136 is stuck to cover 100.

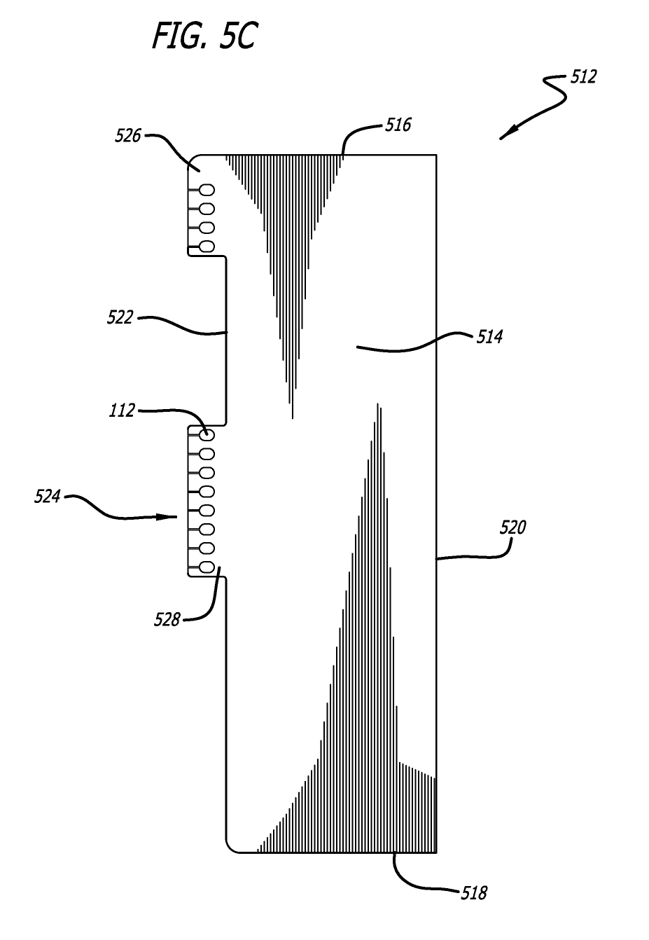

In another embodiment, as illustrated in FIGS. 5A-5B, stationery article can be a page mark 500. Page mark 500 can include a body section 502. Body section 502 can include a top edge 504, a bottom edge 506, an outside edge 508, and an inside edge 510. In some embodiments, top edge 504, and bottom edge 506, and outside edge 508 are substantially flat thereby forming a substantially rectangular or square shape. In some embodiments, page mark 500 is substantially flat and has a rectangular shape.

Page mark 500 also includes at least two securing holes 112 configured to secure body section 502 to a substantially cylindrical binding mechanism 114. Securing holes 112 can be located on inside edge 510. However, in other embodiments, securing holes 112 can be located on top edge 504, bottom edge 506, and/or outside edge 508.

Page mark 500 can include all the features of other stationery articles as described herein and can be formed and used in a similar fashion.

As illustrated in FIG. 5C, stationery article can be an insert 512. Insert 512 can include a body section 514. Body section 514 can include a top edge 516, a bottom edge 518, an outside edge 520, and an inside edge 522. In some embodiments, top edge 516, and bottom edge 518, and outside edge 520 are substantially flat thereby forming a substantially rectangular or square shape. In some embodiments, insert 512 is substantially flat and has a rectangular shape.

Insert 512 can include at least two clusters 524 of securing holes 112 or hole sections configured to secure body section 514 to a substantially cylindrical binding mechanism 114. Securing holes 112 can be located on inside edge 522. However, in other embodiments, securing holes 112 can be located on top edge 516, bottom edge 518, and/or outside edge 520.

In one embodiment, a cluster of securing holes 526 is located at the top of inside edge 522 and another a cluster of securing holes 528 is located at the middle of inside edge 522. In one embodiment, cluster of securing holes 526 can include four hole sections and cluster of securing holes 528 can include eight hole sections.

In another embodiment, cluster of securing holes can be located at the bottom end of an edge and a cluster of securing holes can be located at the middle portion of the edge. The number of holes can vary depending on a particular application. In still another embodiment, a cluster of securing holes can be located at the top end of an edge and a cluster of securing holes can be located at the bottom end of the edge. In still another embodiment, a cluster of securing holes can be located at the top end of an edge, a cluster of securing holes can be located at the middle portion of the edge, and a cluster of hole sections can be located at the bottom end of the edge. Each cluster described can have any number of hole sections. Also, any number of clusters can be used on any number of edges.

Insert 512 can include all the features of other stationery articles as described herein and can be formed and used in a similar fashion.

Any corner of page mark 500 or insert 512 can be rounded, squared, or take on any appropriate shape.

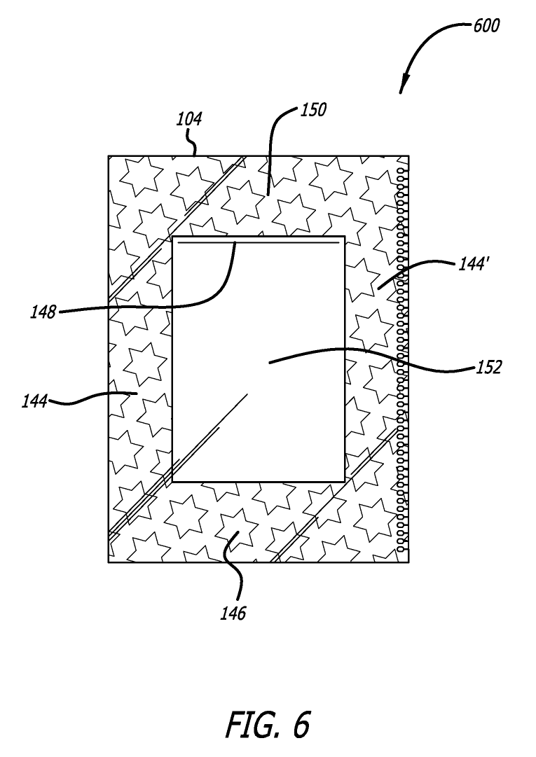

Another embodiment is illustrated in FIG. 6. Cover 600 includes a window section 152 surrounded by first and second side frame portions 144,144′, bottom frame portion 146 and top frame portion 150. In one embodiment, first and second side frame portions 144,144′, bottom frame portion 146 and top frame portion 150 can be laminated and window section 152 is un-laminated sheets of transparent plastic or other polymer. An article such as a photograph can be inserted into window section 152 through opening 148. Opening 148 can be opened and closed using mechanisms such as zippers, zip locks, adhesives, Van deer Walls forces, ionic forces, static forces, combinations thereof, and the like. In some embodiments, a mechanism need not be used.

In one embodiment, a removable article such as a photograph can be inserted through opening 148 and slid down into window section 152 that is behind a transparent section of body section 102. Likewise, in other embodiments, a removable article can be inserted thorough an opening that runs vertically down the right or left side of window section 152.

Window section 152 can have a height and a width. The height of window section 152 can be about 3 inches, about 4 inches, about 5 inches, about 6 inches, about 7 inches, about 8 inches or more. The width of window section 152, sleeve 136, and removable insert 132 can be about 3 inches, about 4 inches, about 5 inches, about 6 inches, or more.

Further still, as illustrated in FIG. 6, removable insert 132 can extend substantially to the edges of body section 102 including, but not limited to within hole sections and slice sections.

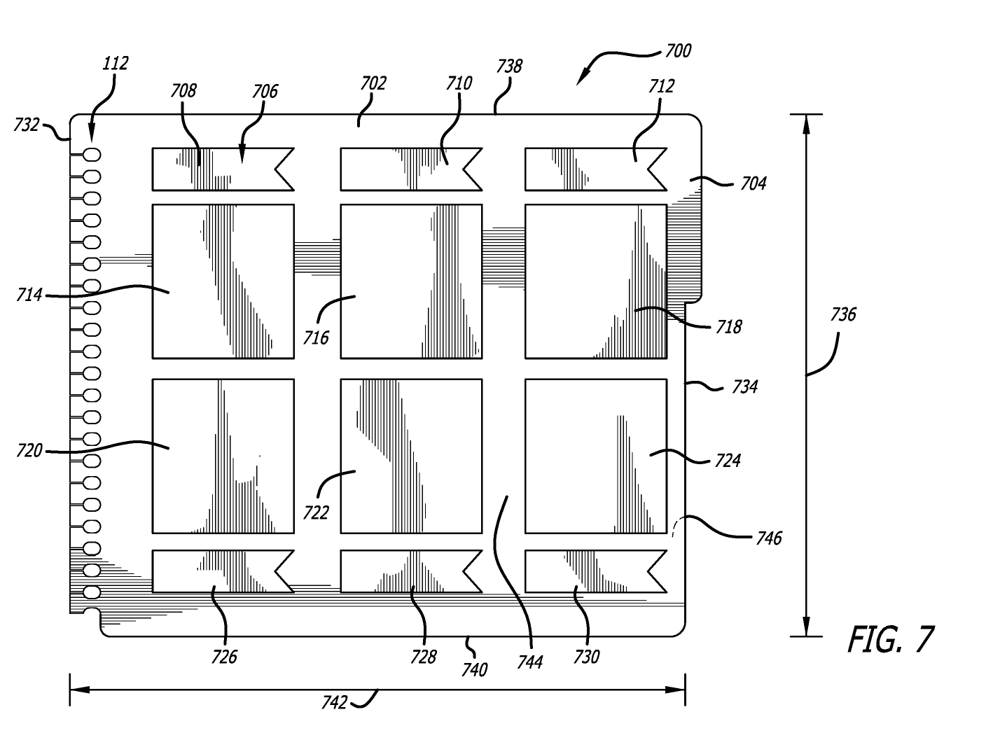

Another embodiment of a dashboard 700 that can be interchangeably attached to a binding mechanism of a bound set of materials as described herein is illustrated in FIG. 7. In some embodiments, dashboard 700 can be referred to as a cover or insert. Dashboard 700 has a body section 702 that can include various features. In one embodiment, dashboard 700 can include a tab 704 that can be configured to identify the location of dashboard 700 within a bound set of materials. In some embodiments, dashboard 700 can be used as a front or back cover.

Further, body section 702 can include one or more removably attached articles 706 or set of articles. Removably attached articles 706 can include sticky tabs, adhesive-backed note pads, stickers, magnets, sticky flags, note tabs and the like. In some embodiments, removably attached articles 706 can include stacks of sticky tabs, adhesive-backed note pads, stacks of stickers, stacks of magnets, stacks of sticky flags, stacks of note tabs, and the like Removably attached articles 706 can be of various colors and/or can have different visual designs to identify the purpose of the removably attached article being used. Further, removably attached articles 706 can have various shapes and sizes that may be desired by a particular user.

Removably attached articles 706 can have at least a portion of its inside surface or base sheet or tab an adhesive that attaches the article to body section 702 in a permanent fashion. In other embodiments, the attachment is not permanent, but has sufficient strength to hold removably attached article onto body 702.

In one embodiment, body section can include first removably attached article 708, second removably attached article 710, third removably attached article 712, fourth removably attached article 714, fifth removably attached article 716, sixth removably attached article 718, seventh removably attached article 720, eighth removably attached article 722, ninth removably attached article 724, tenth removably attached article 726, eleventh removably attached article 728, and twelfth removably attached article 730. In this embodiment, first removably attached article 708, second removably attached article 710, third removably attached article 712, tenth removably attached article 726, eleventh removably attached article 728, and twelfth removably attached article 730 can be sticky flag style articles and fourth removably attached article 714, fifth removably attached article 716, sixth removably attached article 718, seventh removably attached article 720, eighth removably attached article 722, and ninth removably attached article 724 can be sticky note style articles.

In other embodiments, different combinations of articles and/or shapes and sizes of articles can be included on dashboard 700.

In some embodiments, body section 702 can include non-removable articles in addition to or replacing removably attached articles 706. Any number or combination of removably attached articles 706 and non-removable articles can be included on body 702. Non-removable articles can have various shapes and sizes.

Further, body section 702 can include inside edge 732 that includes at least two hole sections 112. In some embodiments, inside edge 732 can be substantially straight. Body portion can also include an outside edge 734 that can be substantially straight but can also be curved or have tabs such as tab 704.

Dashboard 700 can include body section 702 that is dimensioned for a particular application and/or dimensioned to fit within or along a particular binding mechanism. For example, body section 702 can include a height 736 that extends from top edge 738 to bottom edge 740. Height 736 of body section 702 can be long enough to provide enough hole sections 112 to secure dashboard 700 to a binding mechanism. In some embodiments, height 736 can be about 12 inches, about 11.5 inches, about 11 inches, about 10.5 inches, about 10 inches, about 9.5 inches, about 9.25 inches, about 9 inches, about 8.5 inches, about 8 inches, about 7.5 inches, about 7 inches, about 6.5 inches, about 6 inches, about 5.5 inches, about 5 inches, about 4.5 inches, about 4 inches, between about 12 inches and about 11 inches, between about 9 inches and about 10 inches, between about 4 inches and about 6 inches, or between about 4 inches and about 8 inches. In one embodiment, height is about 5.5 inches.

Further, body section 702 can include a width 742 that extends from inside edge 732 to outside edge 734. Width 742 of body section 702 can be long enough to provide enough surface area for dashboard 700 to include a desired number of removably attached articles 706. In some embodiments, width 742 can be about 10 inches, about 9 inches, about 8 inches, about 7 inches, about 7.5 inches, about 7.25 inches, about 7 inches, about 6.5 inches, about 6 inches, about 5.5 inches, about 5 inches, about 4.5 inches, about 4 inches, about 3.5 inches, abut 3 inches, between about 10 inches and about 8 inches, between about 7 inches and about 6 inches, or between about 4 inches and about 3 inches. In one embodiment, width is about 7.25 inches.

Dashboards can also have a thickness. Thickness can be a thickness sufficient to hold articles without deforming shape or cracking. Thickness can be about 0.2 inches, about 0.1 inches, about 0.15 inches, about 0.125 inches, about 0.01 inches, between about 0.01 inches and about 0.1 inches, or between about 0.1 and 0.2. In some embodiments, thickness is at least about 0.1 inches or about 0.12 inches.

Body section in some embodiments can have articles attached to front side 744, to back side 746, or both. For example, if used as a front cover, back side 746 can include articles. Likewise, if used as a back cover, front side 744 can include articles. Further still, if used as an insert, both front side 744 and back side 746 can include articles. When used as an insert, in some embodiments either front side 744 or back side 746 can include articles.

As with other covers described herein, dashboard 700 can be formed of an appropriate material. For example, in some embodiments, dashboard 700 can be formed of a plastic or other polymeric material such as, but not limited to rubber, synthetic rubber, polyesters, silicone polymers, thermoplastics, thermosets, polyolefins, polyisobutylene, acrylic polymers, ethylene-co-vinylacetate, polybutylmethacrylate, vinyl halide polymers (for example, polyvinyl chloride), polyvinyl ethers (for example, polyvinyl methyl ether), polyvinylidene halides, polyacrylonitrile, polyvinyl ketones, polyvinyl aromatics, polyvinyl esters, acrylonitrile-styrene copolymers, ABS resins, ethylene-vinyl acetate copolymers, polyamides (for example, Nylon 66 and polycaprolactam), alkyd resins, polycarbonates, polyoxymethylenes, polyimides, polyethers, epoxy resins, polyurethanes, rayon, cellulose, cellulose acetate, cellulose butyrate, cellulose acetate butyrate, cellophane, cellulose nitrate, cellulose propionate, cellulose ethers, carboxymethyl cellulose, polytetrafluororethylene (for example, TEFLON®) and combinations thereof. In some embodiments, cover 100 can be a plastic or other polymeric material coated onto or covering a paper product. In one embodiment, the cover can be made of a polyester based material with a co-polymer low-melt aggressive adhesive. The cover can be 5 mil, 10 mil, 20 mil, 30 mil or more in thickness.

In some embodiments, dashboard 700 can include at least a portion thereof that is at least partially transparent. In one embodiment, the entirety of dashboard 700 is at least partially transparent.

Also, in other embodiments, dashboard 700 can be formed of a metal such as, but not limited to aluminum, titanium, zinc, platinum, tantalum, copper, nickel, rhodium, gold, silver, palladium, chromium, iron, indium, ruthenium, osmium, tin, iridium, or combinations, and alloys thereof.

Dashboard 700 can also be formed of metal or a textile such as paper and coated or encased in a polymer or plastic. In some embodiments, the encasement can be a lamination.

Dashboard can be formed as or include any other feature described herein.

In one embodiment, body section 702 can include removably attached articles for example on the top portion of body section 702 and a pouch for holding loose materials can be located on the bottom portion of body section 702. In some embodiments, this orientation be reversed or can be oriented right and left. In one embodiment, article 700 can be used as an interchangeable back cover.

Cover 100 and/or dashboard 700 can be formed by any method that can provide a cover and/or dashboard 700 with desired properties as described herein. For example, covers and/or dashboard 700 can be formed by injection molding, 3D printing, lamination, punching from a sheet of material, casting, a combination thereof, or the like.

In one embodiment, covers, dashboards, and/or other stationery articles can be punched using a die or multiple dies. Sheets of polymeric material of an appropriate thickness can be used. In some embodiments, multiple covers and/or dashboards can be punched in a single pass as a single unit from a larger piece of material. In other embodiments, covers and/or dashboards can be punched out separately.

In another embodiment, a roll of polymeric material can be fed into a die cutting machine with a wheel that continuously cuts out covers and/or dashboards.

Other methods of manufacture are also within the scope of the present disclosure.

Methods of using the herein described stationery articles are also described. In some embodiments, methods can include attaching or securing stationery articles described to a binding mechanism and then having the ability to remove the stationery article upon demand with an appropriate force or maneuver. Attaching or securing the stationery article to the binding mechanism can be accomplished using at least one hole section or at least two hole sections as described herein.

The securing step can be accomplished by providing enough force to snap or otherwise attach or secure the at least one hole section onto a ring of a binding mechanism. This snapping forces the ring through the slice section and into the hole section of the stationery article thereby securing it in place. Snapping can be referred to as attaching, securing, clipping, connecting, or the like. Snapping can be used to describe both the force to secure the at least one hole section onto a ring of a binding mechanism as well as the sound the stationary article makes when it is secured or removed. The sound can be the plastic or polymer “snapping” around the binding mechanism. In other words, snapping is used in a non-limiting manner and other terms can be used to described this action.

In some embodiments, the slice section does not have a substantial thickness but is rather a slice of the body section material. Thus, a spiral is held within the hole section because the slice section remains closed until force is used to remove the body section from the binding mechanism. In some embodiments, the two portions sliced in slice section bend apart to allow a portion of a binding mechanism to make it into and out of a hole section. In other embodiments, slice section can have a gap that allows a binding mechanism to slide in and out of a hole section. However, a slice gap can be smaller than a ring of a binding mechanism to require force to remove a body section from a binding mechanism.

The stationery article can then be removed from the binding mechanism using an appropriate force, maneuver, or both. In some embodiments, force can be used to pull the stationery article off the binding mechanism by forcing the binding mechanism ring out of the hole section through the slice section. In another embodiment, the stationery article can be removed from the binding mechanism using a force along with a maneuver similar to that of tearing a sheet of paper out of a spiral notebook. For example, a user can grasp a corner such as at the intersection of the outer edge and the top edge or the outer edge and the bottom edge and tear the stationery article up and away from the binding mechanism.

Stationery articles described herein can be provided as kits, as a part of a kit, as an item that can be added to a kit, or as a completely independent article. A kit can include a bound article, a removable cover and/or other stationery article as described herein, and instructions for use thereof. Kits can include two, three, four, or more covers and/or other stationery articles. In other embodiments, a kit can include a bound article such as a booklet, pamphlet, notebook or the like having a binding mechanism as described herein and at least one removable cover or other stationery article as described herein. For example, a spiral bound booklet and at least one removable cover and/or other stationery article can be packaged with or without instructions for use as a kit. In other embodiments, a removable cover(s) can be included in kits with instructions that demonstrate how to add and remove the cover from a bound article. In other embodiments, a kit can include at least one removable cover and/or other stationery article as described herein and instructions for use.

Unless otherwise indicated, all numbers expressing quantities of ingredients, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing embodiments (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

The use of the term “or” in the claims is used to mean “and/or” unless explicitly indicated to refer to alternatives only or the alternatives are mutually exclusive, although the disclosure supports a definition that refers to only alternatives and “and/or.”

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments are described herein, including the best mode known for carrying out the invention. Of course, variations on those preferred embodiments will become apparent to those of ordinary skill in the art upon reading the foregoing description. Those of ordinary skill in the art are expected to employ such variations as appropriate, and embodiments described herein are to be practiced otherwise than specifically described herein. Accordingly, embodiments herein include all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Further, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A stationery article comprising:
a body section including a top surface, a bottom surface, an inside edge and an outside edge, wherein at least a portion of the inside edge includes two or more securing holes that interchangeably attach the stationery article to a substantially cylindrical binding mechanism.

2. The stationery article of claim 1, wherein the two or more securing holes include a hole section and a slice section.

3. The stationery article of claim 2, wherein the hole section is elliptical.

4. The stationery article of claim 1, including 44 securing holes.

5. The stationery article of claim 1, including 35 securing holes.

6. The stationery article of claim 1, wherein the body section is rectangular.

7. The stationery article of claim 1, wherein the top surface and the bottom surface are substantially flat.

8. The stationery article of claim 1, wherein the body includes a height from the top edge to the bottom edge of about 11.5 inches.

9. The stationery article of claim 1, wherein the body includes a height from the top edge to the bottom edge of about 9.25 inches.

10. The stationery article of claim 1, wherein the body section includes an insert.

11. The stationery article of claim 1, wherein the body section includes one or more removably attached articles.

12. A method of using a stationery article, the method comprising
interchangeably securing a body section of the stationery article to a substantially cylindrical binding mechanism using two or more securing holes.

13. The method of claim 12, wherein the body section includes a top edge, a bottom edge, an inside edge and an outside edge, wherein at least a portion of the inside edge includes the two or more securing holes that interchangeably attach the stationery article to the substantially cylindrical binding mechanism.

14. The method of claim 12, further comprising:
removing the body section of the stationery article from the substantially cylindrical binding mechanism.

15. The method of claim 14, wherein the removing is accomplished using a tearing motion with the body section.

16. The method of claim 14, further comprising:
re-securing the body section of the stationery article to the substantially cylindrical binding mechanism.

17. The method of claim 12, further comprising:
attaching a sleeve with a pocket onto the body section.

18. The method of claim 12, wherein the interchangeably securing includes using force to attach the two or more securing holes onto the substantially cylindrical binding mechanism.

19. The method of claim 12, wherein the two or more securing holes each include a hole section and a slice section.

20. The method of claim 19, wherein the interchangeably securing includes using force to attach the hole sections onto the substantially cylindrical binding mechanism through the slice sections.
